(19) United States
(12) Patent Application Publication
(10) Pub. No.: US 2022/0038455 A1
(43) Pub. Date: Feb. 3, 2022

(54) METHOD FOR TRIGGERING OUTREACH BASED ON THIRD PARTY DATA REQUESTS

(71) Applicant: Capital One Services, LLC, McLean, VA (US)

(72) Inventors: Abdelkader M'Hamed Benkreira, New York, NY (US); Michael Mossoba, Arlington, VA (US); Joshua Edwards, Philadelphia, PA (US)

(21) Appl. No.: 16/983,089

(22) Filed: Aug. 3, 2020

(51) Int. Cl. H04L 29/06; G06N 20/00; G06Q 20/40

(52) U.S. Cl. CPC H04L 63/0876; G06Q 20/40; G06N 20/00

(57) ABSTRACT

The communication techniques described herein may allow a server to send communications to user devices in response to detecting a user interacting with an application and/or their device. A request to access information associated with an account may be detected. Next, a determination may be made as to whether the request is from a third-party and/or initiated by the user. When the request is from a third-party and/or initiated by the user, a customer outreach module may be triggered, which may select a communication to send to the user. A verification of whether the user allows for receipt of communications may be performed. When the user accepts communications, the communication may be sent to the user device. Accordingly, sending communications when the user may be interacting with an application and/or device improves the probability of the user interacting with the communication and the user receiving the information associated with the communication.

### FIELD OF USE

Aspects of the disclosure relate generally to electronic communications and more specifically to communications based on interaction with a device.

### BACKGROUND

Aggregator applications, such as financial aggregators, aggregate information from different sources and provide the aggregated information in a single location. For example, financial aggregator applications may gather information from financial institutions (e.g., banks), investment firms, credit cards, etc. and cause the relevant information to be displayed in a single interface. While aggregator applications are useful, the services and/or applications they gather information from may need to communicate with users. For instance, the financial institutions (e.g., banks), investment firms, credit cards, etc. may need to communicate with users for a variety of reasons, such as tax reasons, update account information, update information (e.g., personal, professional, etc.), to name a few. However, the users may not interact with the services and/or applications associated with the financial institutions (e.g., banks), investment firms, credit cards, etc., and instead, only interact with their account through the aggregator application.

### SUMMARY

The following presents a simplified summary of various features described herein. This summary is not an extensive overview, and is not intended to identify key or critical elements or to delineate the scope of the claims. The following summary merely presents some concepts in a simplified form as an introductory prelude to the more detailed description provided below. Corresponding apparatus, systems, and computer-readable media are also within the scope of the disclosure.

Methods, devices, systems, and/or computer-readable media described herein may determine when and how to attempt to communicate with a user. A server may detect a request to access information associated with an account. The server may analyze the request to determine whether the request was from a client-side application associated with the server or a third-party. When the request was initiated by a third-party, the server may determine whether the request was user-initiated or a routine data gathering request. When the request was initiated by a user, the server may trigger a customer outreach. In this regard, the server may determine whether there are any communications pending for the user. If there are pending communications, the server may select one of the communications and verify that the user does not have any restrictions (e.g., do-not-call, do not contact preferences, etc.) in place. If the user does not have any restrictions in place, the server may send the communication to the user. In this regard, the server may improve the probability of the user interacting with a communication and providing information associated with the account by sending the communication when the server detects the user interacting with their device and/or an aggregator application.

These features, along with many others, are discussed in greater detail below.

### BRIEF DESCRIPTION OF THE DRAWINGS

The present disclosure is described by way of example and not limited in the accompanying figures in which like reference numerals indicate similar elements and in which:

FIG. 1 shows an example of a system in which one or more features described herein may be implemented;

FIG. 2 shows an example computing device;

FIG. 3 shows an example of a process for determining whether to communicate with a user in accordance with one or more aspects of the disclosure;

FIGS. 4A and 4B show an example of contacting a user via a mobile device according to one or one more aspects of the disclosure; and

FIG. 5 shows an example of a process for updating a communication selection algorithm in accordance with one or more aspects of the disclosure.

### DETAILED DESCRIPTION

In the following description, reference is made to the accompanying drawings, which form a part hereof, and in which are shown various examples of features of the disclosure and/or of how the disclosure may be practiced. It is to be understood that other features may be utilized and structural and functional modifications may be made without departing from the scope of the present disclosure. The disclosure may be practiced or carried out in various ways. In addition, it is to be understood that the phraseology and terminology used herein are for the purpose of description and should not be regarded as limiting. Rather, the phrases and terms used herein are to be given their broadest interpretation and meaning.

By way of introduction, features discussed herein may relate to methods, devices, systems, and/or computer-readable media for sending communications to a user based on a determination that the user is interacting with one or more applications on their device. This may improve the likelihood of the user interacting with the communication. Furthermore, sending communications based on a user interacting with their device may have a better probability of being seen by the user, instead of being lost in a sea of endless alerts and/or communications.

Methods, devices, systems, and/or computer-readable media described herein may comprise detecting a request to access information associated with an account. The request may be received from a third-party and be initiated by the user. In these instances, a customer outreach module may be triggered. The customer outreach module may select one of a plurality of communications to send to the user and verify that the user allows receipt of communications. When the user allows receipt of communications, the communication may be sent to the user. In this regard, sending communications when the user may be interacting with a third-party application improves the probability of the user interacting with the communication and user receiving the information associated with the communication.

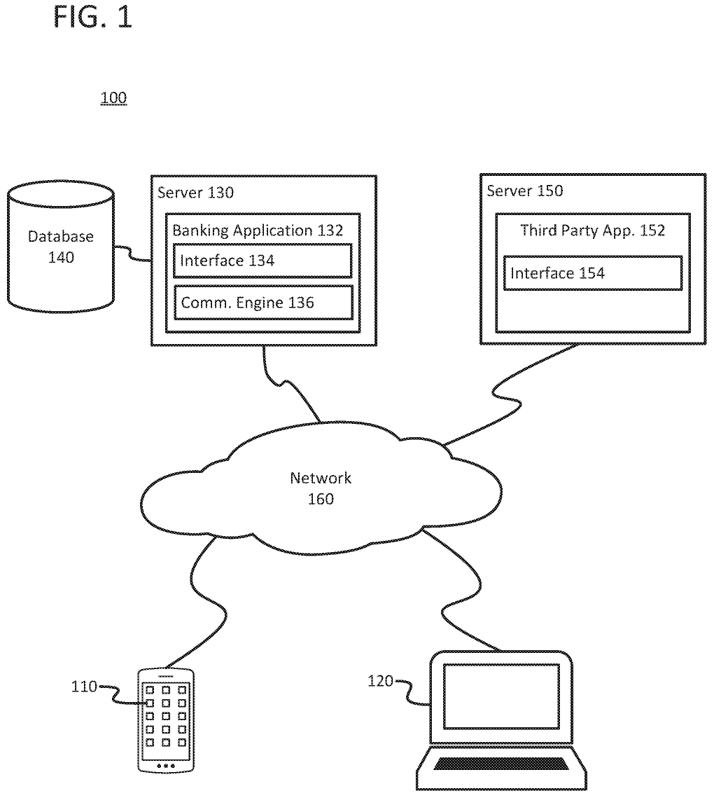

FIG. 1 shows an example of a system 100 that includes a first user device 110, a second user device 120, a first server 130—connected to a first database 140, and a second server 15 all interconnected via network 160.

First user device 110 may be a mobile device, such as a cellular phone, a mobile phone, a smart phone, a tablet, or a laptop. First user device 110 may provide a first user with access to various applications and services. For example, first user device 110 may provide the first user with access to the Internet. Additionally, first user device 110 may provide the first user with one or more applications (“apps”) located thereon. The one or more applications may provide the first user with a plurality of tools and access to a variety of services. In some embodiments, the one or more applications may comprise a banking application that provides access to the first user's banking information, as well as perform routine banking functions, such as checking the first user's balance, paying bills, transferring money between accounts, withdrawing money from an automated teller machine (ATM), and wire transfers. Additionally or alternatively, the one or more applications may comprise one or more aggregator applications, such as a financial aggregation application, like Mint®, Tiller Money, YNAB (You Need A Budget), PocketSmith, Banktivity, etc.

Second user device 120 may be a computing device configured to allow a user to execute software for a variety of purposes. Second user device 120 may belong to the first user that accesses first user device 110, or, alternatively, second user device 120 may belong to a second user, different from the first user. Second user device 120 may be a desktop computer, laptop computer, or, alternatively, a virtual computer. The software of second user device 120 may include one or more web browsers that provide access to websites on the Internet. These websites may comprise banking websites that allow the user to access his/her banking information and perform routine banking functions. The banking application that allows the user to access his/her banking information and perform routine banking functions. The user may also access other websites, such as financial aggregation and/or money management sites, like Mint®, Personal Capital, Tiller, etc.

First server 130 may be any server capable of executing banking application 132. Additionally, server 130 may be communicatively coupled to first database 140. In this regard, server 130 may be a stand-alone server, a corporate server, or a server located in a server farm or cloud-computer environment. According to some examples, server 130 may be a virtual server hosted on hardware capable of supporting a plurality of virtual servers.

Banking application 132 may be server-based software configured to provide users with access to their account information and perform routing banking functions. In some embodiments, banking application 132 may be the server-based software that corresponds to the client-based software executing on first user device 110 and second user device 120. Banking application 132 may comprise an interface 134 and a communication engine 136. Interface 134 may allow first user device 110 and second user device 120 to communication with banking application 132. Interface 134 may also allow users to access their account information through a website. Additionally or alternatively, interface 134 may allow third parties to query banking application 132 to obtain data and/or information. In this regard, interface 134 may comprise an application programming interface (API). Communication engine 136 may generate, aggregate, and/or send one or more communications to user devices on behalf of banking application 132. Communication engine 136 may comprise a customer outreach module that triggers the selection and sending of one or more communications in response to determining a user is interacting with an application and/or their device. In this regard, banking application 132 may need to communicate information to users. For example, banking application 132 may ask users to verify and/or update their personal information, their contact information, and/or their professional information. In some examples, the banking application 132 may send offers and/or promotions to users. Additionally or alternatively, banking application 132 These communications comprise one or more of: a push notification to a mobile device, an electronic communication (e.g., a text message, an email, etc.), or a pre-recorded communication via a phone call.

First database 140 may be configured to store information on behalf of application 132. The information may include, but is not limited to, personal information, account information, and user-preferences. Personal information may include a user's name, address, phone number (e.g., mobile number, home number, business number, etc.), social security number, username, password, employment information, family information, and any other information that may be used to identify the first user. Account information may include account balances, bill pay information, direct deposit information, wire transfer information, statements, and the like. User-preferences may define how users receive notifications and alerts, spending notifications, and the like. First database 140 may include, but are not limited to relational databases, hierarchical databases, distributed databases, in-memory databases, flat file databases, XML databases, NoSQL databases, graph databases, and/or a combination thereof.

Second server 150 may be any server capable of executing application 152. In this regard, second server 150 may be a stand-alone server, a corporate server, or a server located in a server farm or cloud-computer environment. According to some examples, second server 150 may be a virtual server hosted on hardware capable of supporting a plurality of virtual servers.

Application 152 may be server-based software that corresponds to one or more aggregator applications. That is, application 152 may be server-based software that corresponds to the client-based software executing on first user device 110 and/or second user device 120. Application 152 may comprise an interface 154 to obtain information on behalf of a user, aggregate the information, and display the aggregated information. Interface 154 may gather the information from a plurality of sources. For example, interface 154 may obtain information from banking application 152, as well as other financial institutions, creditors, investment banks, brokerage houses, etc. Interface 154 may allow users to access their aggregated information through a website. Interface 154 may gather the information via an application programming interface (API), data scraping algorithm, and/or an equivalent thereof.

Network 160 may include any type of network. In this regard, network 160 may include the Internet, a local area network (LAN), a wide area network (WAN), a wireless telecommunications network, and/or any other communication network or combination thereof. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. The data transferred to and from various computing devices in system 100 may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. For example, a file-based integration scheme or a service-based integration scheme may be utilized for transmitting data between the various computing devices. Data may be transmitted using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and users to support input, extraction, and manipulation of data between the various computing devices in the system 100. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. For example, secure network appliances may include built-in features such as hardware-accelerated SSL and HTTPS, WS-Security, and/or firewalls. Such specialized hardware may be installed and configured in system 100 in front of one or more computing devices such that any external devices may communicate directly with the specialized hardware.

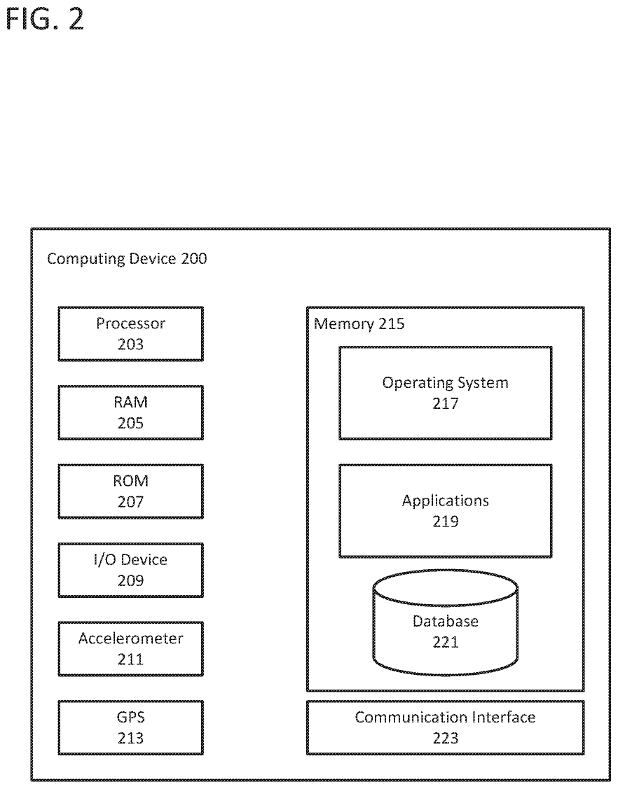

Any of the devices and systems described herein may be implemented, in whole or in part, using one or more computing devices described with respect to FIG. 2. Turning now to FIG. 2, a computing device 200 that may be used with one or more of the computational systems is described. The computing device 200 may comprise a processor 203 for controlling overall operation of the computing device 200 and its associated components, including RAM 205, ROM 207, input/output device 209, accelerometer 211, global-position system antenna 213, memory 215, and/or communication interface 223. A bus 202 may interconnect processor(s) 203, RAM 205, ROM 207, memory 215, I/O device 209, accelerometer 211, global-position system receiver/antenna 213, memory 215, and/or communication interface 223. Computing device 200 may represent, be incorporated in, and/or comprise various devices such as a desktop computer, a computer server, a gateway, a mobile device, such as a laptop computer, a tablet computer, a smart phone, any other types of mobile computing devices, and the like, and/or any other type of data processing device.

Input/output (I/O) device 209 may comprise a microphone, keypad, touch screen, and/or stylus through which a user of the computing device 200 may provide input, and may also comprise one or more of a speaker for providing audio output and a video display device for providing textual, audiovisual, and/or graphical output. Software may be stored within memory 215 to provide instructions to processor 203 allowing computing device 200 to perform various actions. For example, memory 215 may store software used by the computing device 200, such as an operating system 217, application programs 219, and/or an associated internal database 221. As noted above, application programs 219 may comprise at least one of a banking application and one of an aggregator application (e.g., financial aggregator application). The various hardware memory units in memory 215 may comprise volatile and nonvolatile, removable and non-removable media implemented in any method or technology for storage of information such as computer-readable instructions, data structures, program modules, or other data. Memory 215 may comprise one or more physical persistent memory devices and/or one or more non-persistent memory devices. Memory 215 may comprise random access memory (RAM) 205, read only memory (ROM) 207, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 203.

Accelerometer 211 may be a sensor configured to measure accelerating forces of computing device 200. Accelerometer 211 may be an electromechanical device. Accelerometer may be used to measure the tilting motion and/or orientation computing device 200, movement of computing device 200, and/or vibrations of computing device 200. The acceleration forces may be transmitted to the processor to process the acceleration forces and determine the state of computing device 200.

GPS receiver/antenna 213 may be configured to receive one or more signals from one or more global positioning satellites to determine a geographic location of computing device 200. The geographic location provided by GPS receiver/antenna 213 may be used for navigation, tracking, and positioning applications. In this regard, the geographic may also include places and routes frequented by the first user.

Communication interface 223 may comprise one or more transceivers, digital signal processors, and/or additional circuitry and software, protocol stack, and/or network stack for communicating via any network, wired or wireless, using any protocol as described herein.

Processor 203 may comprise a single central processing unit (CPU), which may be a single-core or multi-core processor, or may comprise multiple CPUs. Processor(s) 203 and associated components may allow the computing device 200 to execute a series of computer-readable instructions (e.g., instructions stored in RAM 205, ROM 207, memory 215, and/or other memory of computing device 215, and/or in other memory) to perform some or all of the processes described herein. Although not shown in FIG. 2, various elements within memory 215 or other components in computing device 200, may comprise one or more caches, for example, CPU caches used by the processor 203, page caches used by the operating system 217, disk caches of a hard drive, and/or database caches used to cache content from database 221. A CPU cache may be used by one or more processors 203 to reduce memory latency and access time. A processor 203 may retrieve data from or write data to the CPU cache rather than reading/writing to memory 215, which may improve the speed of these operations. In some examples, a database cache may be created in which certain data from a database 221 is cached in a separate smaller database in a memory separate from the database, such as in RAM 205 or on a separate computing device. For example, in a multi-tiered application, a database cache on an application server may reduce data retrieval and data manipulation time by not needing to communicate over a network with a back-end database server. These types of caches and others may provide potential advantages in certain implementations of devices, systems, and methods described herein, such as faster response times and less dependence on network conditions when transmitting and receiving data.

Although various components of computing device 200 are described separately, functionality of the various components may be combined and/or performed by a single component and/or multiple computing devices in communication without departing from the disclosure.

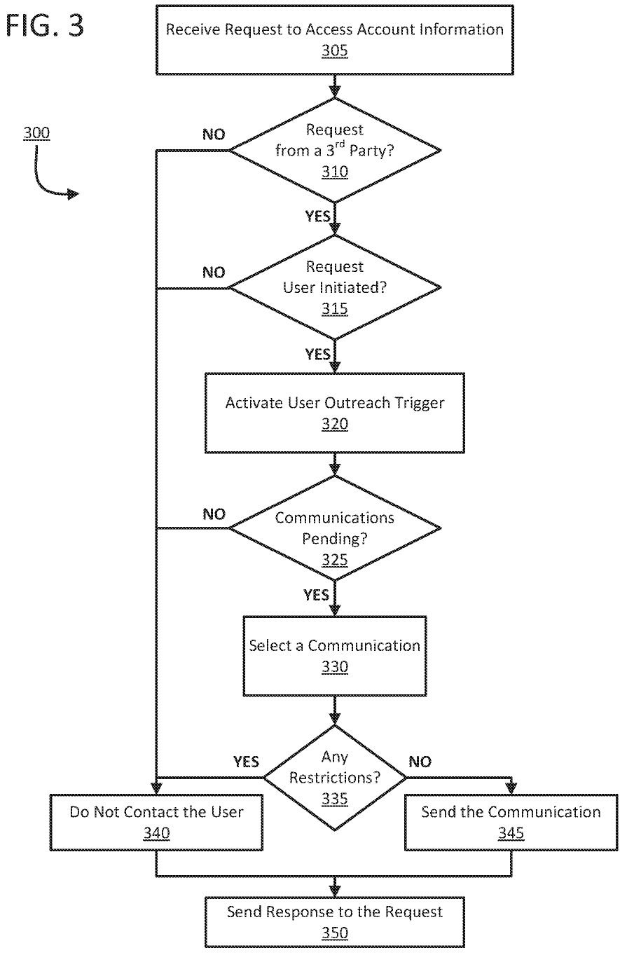

Aggregator applications, such as financial aggregator applications, may aggregate and display information associated with a plurality of accounts. However, the aggregator applications may not provide communications from the services from which they aggregate the information. Those services may need to communicate with their accountholders. FIG. 3 shows a flow chart of a process 300 for determining whether to communicate with a user according to one or more aspects of the disclosure. Some or all of the steps of process 300 may be performed using one or more computing devices as described herein, such as first server 130.

In step 305, a server (e.g., banking application 132 executing on first server 130) may receive a request to access information related to an account associated with a user. The request to access information may comprise at least one of: a first identifier, a second identifier, and/or a third identifier. The first identifier may indicate a party making the request. For example, a second server (e.g., second server 150 executing aggregator application 152) may be the party making the request for information associated with the user's account. Alternatively, the second identifier may comprise an application identifier associated with a client-side application executing on a user device (e.g., a banking application on first user device 110). The second identifier may indicate the account, for example, using an account number, a nickname, or some other information associated with the account. In some examples, the user may limit which accounts the second server may access, even at the same financial institution. The third identifier may indicate authorization to access the account. Authorization may comprise a username and password associated with the account. Additionally or alternatively, the authorization may comprise a token, such as an API key.

In step 310, the server may determine the party making the request. In this regard, the request may be received from a client-side application or a second server, such as second server 150 hosting application 152. In this regard, a user may access their account information via the client-side application. The server may recognize that the request is from a client-side application and determine that the server should not contact the user in step 340. Alternatively, the request may be a request made by a third-party. The request may be a query (e.g., REST API) and/or part of a scraping algorithm, for example, via interface 132 and/or interface 152. In some examples, the first identifier, the second identifier, and/or the third identifier may be used to determine the party making the request.

If the request was initiated by a third-party, the server may determine who initiated the request to access the information in step 315. In this regard, aggregator applications may periodically request data associated with the accounts, for example, as part of a data aggregation routine. For example, a financial aggregator app may request account information during the same time window, every day. Additionally or alternatively, the server may determine that the request is part of a batch data gathering process if the server receives a plurality of the same (or similar) requests. Alternatively, the user may have initiated the request. For instance, the user may be accessing their account information via the aggregator application. In another example, an application associated with the account may execute a screen scaping algorithm that detects that the user is interacting with their device. In further examples, the server may determine whether the request to access information was initiated by the user using a machine learning model. The machine learning model may be trained to predict whether a user initiated the request. The machine learning model may be a neural network, such as a generative adversarial network (GAN) or a consistent adversarial network (CAN), such as a cyclic generative adversarial network (C-GAN), a deep convolutional GAN (DC-GAN), GAN interpolation (GAN-INT), GAN-CLS, a cyclic-CAN (e.g., C-CAN), or any equivalent thereof. The neural network may be trained using supervised learning, unsupervised learning, back propagation, transfer learning, stochastic gradient descent, learning rate decay, dropout, max pooling, batch normalization, long short-term memory, skip-gram, or any equivalent deep learning technique. The machine learning model may determine that the request is user-initiated (e.g., not a batch request), for example, based on at least one of: a time of the request, a number of requests that are similar to the request, a service level agreement, the type of request, how much data is being requested, etc.

When the server determines that the request was user-initiated, the server may activate a trigger associated with user outreach in step 320. In some examples, triggering user outreach may comprise setting a flag to send one or more communications to the user. The customer outreach module may set a flag or cause the outreach to be triggered. In step 325, the server may determine that one or more communications are pending for the user, for example, based on the activating the outreach trigger. These communications may comprise an alert, an account notice, a request for additional information, a promotional offer, or an equivalent thereof. For example, the alert may be that the user's password is going to expire. In another example, the alert may indicate the need to update user information, such as personal information, contact information, professional information, etc. The account notice may comprise an increase in a spending limit of a credit card or that the user is approaching their spending limit. The additional information may request that the user update and/or confirm their mailing address. Alternatively, the additional information may be a request for a user to provide updated income information, for example, if the service notices deposits made from a different entity. If there are no communications pending, the process proceeds to step 340, with the server not contacting the user.

However, when there are communications pending, the server may select a first communication from the one or more communications to send to the user in step 330. The server may select the one or more communications, for example, by determining a type of information associated with the request to access information. The type of information associated with the request to access information may comprise an account status check, an income verification, a credit history check, etc. Additionally or alternatively, the server may select the one or more communications, for example, based on priority. For example, providing users with tax documents may be higher priority than promotional offers. Additionally, updating personal information or employment information may be a higher priority than an offer to increase a spending limit.

In step 335, the server may determine whether there are any restrictions on sending the one or more communications to the user device. In this regard, a user may have defined one or more preferences for receiving communications from the server. For example, the user may have indicated that they do not want to receive promotional offers, but allows receipt of other communications related to personal information, professional information, tax documents, etc. Additionally or alternatively, the user may define their preferences for how they receive communications. For example, the user may prefer to receive electronic communications (e.g., text messages, emails, push notifications, etc.) instead of phone calls, or vice versa. In some examples, the server may verify whether the user is on the “Do Not Call” list. If the user has blocked communications from the server, then the server may not contact the user in step 340. However, when the user allows communications from the server, the server may send the communication in step 345. The communication may be sent, for example, as a push notification to a user device, an electronic communication (e.g., text message, e-mail, etc.), and/or a pre-recorded communication via a phone call.

In step 350, the server may send a response to the request to access information. In this regard, if the request is from a client-side application associated with the account, the response may comprise a successful login attempt, which provides the client-side application with direct access to the information. Alternatively, the response may comprise account information, for example, when the request originated from a third-party, such as application 152 executing on the second server 150. The account information may be sent to the second server, which may cause the account information to be displayed on a user device.

The techniques described above may improve the likelihood of a user interacting with a communication sent (e.g., transmitted) by a server. In this regard, sending communications based on a user is interacting with their device may have a better probability of being seen by the user, instead of being diminished by other alerts and/or communications.

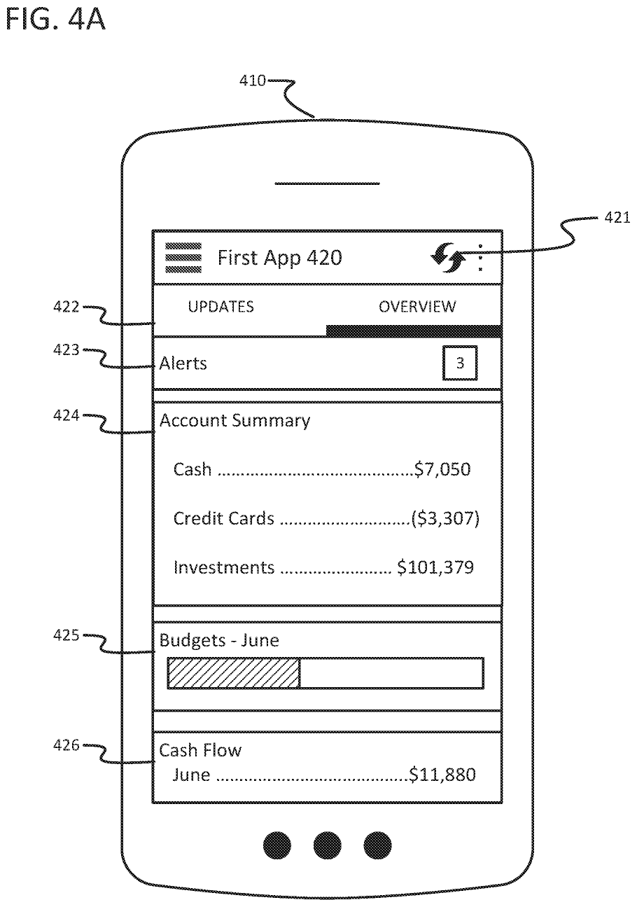

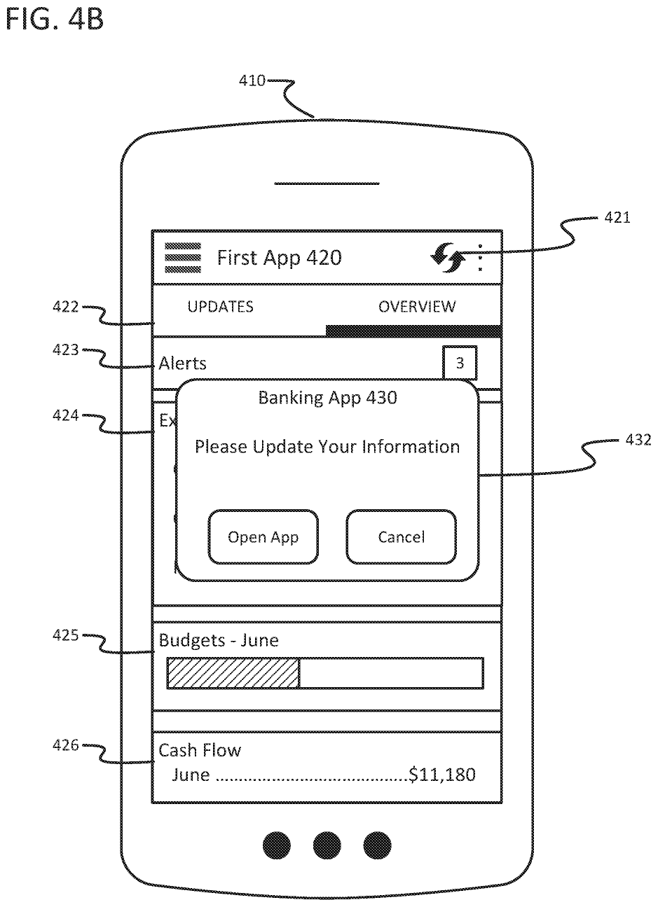

FIGS. 4A and 4B show an example of contacting a user via mobile device 410 according to one or one more aspects of the disclosure. Mobile device 410 may be similar to the devices described above with respect to first user device 110 and/or second user device 120. Mobile device 410 may comprise a first app 420. The first app 420 may be an aggregator app and, in particular, a financial aggregator app, like Mint or Banktivity. The first app 420 may comprise a refresh button 421, a navigation menu 422, an alerts section 423, an account summary section 424, a budget section 425, and/or a cash flow section 426. The refresh button 421 may be configured to update the information displayed by first app 420. The navigation menu 422 may allow a user to swipe between different views (e.g., “Updates,” “Overview”). The alerts section 423 may be configured to notify the user that they have pending alerts. By clicking alerts section 423, the user may be taken to a different screen where they can view and/or manage their alerts. The account summary section 424 may be configured to provide a summary of the accounts that the user has provided first app 420 with access. Accordingly, first app 420 may summarize the user's cash holding, credit card debt, investments, etc. The budget section 425 may indicate whether the user is adhering to their budget. Finally, the cash flow section 426 may provide an indication of the user's monthly cash flow.

Based on the user's interaction with first app 420, a server may determine that the user is interacting with their device and that there is an increased likelihood that the user will interact with a communication. As discussed above, the user interaction may be selection of refresh button 421. In this regard, first app 420 may request updated account information from each of the linked accounts, for example, in response to the user clicking refresh button 421. Alternatively, another application located on mobile device 410 may be executing a screen scraping algorithm that detects the user's interaction with the first app 420. The interactions may be sent (e.g., transmitted) to a server, which determines that the user is interacting with their device, for example, using the techniques described above with respect to FIG. 3. After the server determines that the user is interacting with their device, the server may send (e.g., transmit) a communication to mobile device 410. As shown in FIG. 4B, a banking app 430 may receive a push notification 432 from the server. Push notification 432 may be displayed over first app 420 and provide the user with the option of opening banking app 430 or closing push notification 432. While a push notification is displayed in FIG. 4B, it will be appreciated that the communication may be a text message, an email, a phone call, etc.

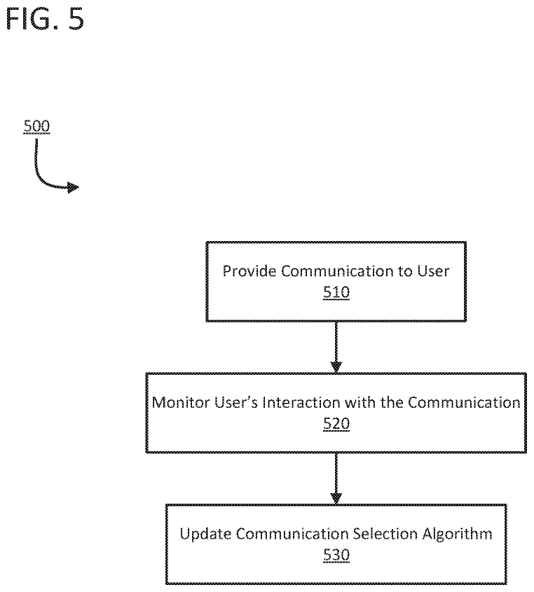

To further improve end user experiences and increase the likelihood of users interacting with the communication, the communication selection algorithm may be updated periodically. FIG. 5 shows a flow chart of a process 500 for updating a communication selection algorithm according to one or more aspects of the disclosure. Some or all of the steps of process 500 may be performed using one or more computing devices as described herein.

In step 510, a server (e.g., banking application 132 executing on the first server 130) may provide one or more communications to a user device. As discussed above, the communications may be text messages, push notifications, emails, electronic communications through an application and/or web interface, or the like. In some examples, the communications may comprise tracking software. In step 520, the server may monitor the one or more communications to determine whether the user engages with the one or more communication. In this regard, the tracking software may be embedded in the one or more communications. The tracking software may determine whether the user opens (e.g., clicks on) the one or more communications, whether the user deletes the one or more communications without reading them, how much time they interact with the one or more communications, if they click on links embedded in the one or more communications, etc. Additionally or alternatively, the server may monitor whether the user clicks on one or more links embedded in the one or more communications, for example, by using customized links that identify the user. In some examples, the server may monitor whether the user logs into their account within a predetermined time of the one or more communications being sent. In step 530, the server may update one or more algorithms used to select the one or more communications sent to the user. The update may be based on a determination that the user engages with the one or more communications. Additionally or alternatively, the update may be based on how the user engages with the one or more communications. For example, if the user deletes one or more promotional offers, the communication selection algorithm may deprioritize promotional communications. Alternatively, the user may provide additional information, such as updated income and/or professional information, for example, in response to receiving the one or more communications. The communication selection algorithm may prioritize communications related to investments, for example, based on the updated information provided by the user.

The above-described systems, devices, and methods may improve when and which communications are sent to a user, thereby increasing the likelihood of the user interacting with the communication and/or the application associated therewith.

One or more features discussed herein may be embodied in computer-usable or readable data and/or computer-executable instructions, such as in one or more program modules, executed by one or more computers or other devices as described herein. Program modules may comprise routines, programs, objects, components, data structures, and the like. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. The functionality of the program modules may be combined or distributed as desired. In addition, the functionality may be embodied in whole or in part in firmware or hardware equivalents such as integrated circuits, field programmable gate arrays (FPGA), and the like. Particular data structures may be used to more effectively implement one or more features discussed herein, and such data structures are contemplated within the scope of computer executable instructions and computer-usable data described herein. Various features described herein may be embodied as a method, a computing device, a system, and/or a computer program product.

Although the present disclosure has been described in terms of various examples, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present disclosure may be practiced otherwise than specifically described without departing from the scope and spirit of the present disclosure. Although examples are described above, features and/or steps of those examples may be combined, divided, omitted, rearranged, revised, and/or augmented in any desired manner. Thus, the present disclosure should be considered in all respects as illustrative and not restrictive. Accordingly, the scope of the disclosure should be determined not by the examples, but by the appended claims and their equivalents.

What is claimed is:

1. A method comprising:
receiving, by a first device, a request to access information relating to an account associated with a user, wherein the request to access information comprises a first identifier indicating a party making the request, a second identifier indicating the account, and a third identifier indicating authorization to access the account;
determining whether the party making the request is a third party;
determining whether the request to access information was initiated by the user via the third party, wherein the determining that the request to access information was initiated by the user via the third party comprises using a machine learning model trained to predict whether the request comprises a user-initiated request;
based on a determination that the party making the request is a third party and that the request to access information was a user-initiated request, determining that the user is accessing the account via a third-party application;
activating, based on the determining that the user is accessing the account via the third-party application, a trigger associated with user outreach;
determining, based on the activating the trigger, that one or more communications are pending for the user, wherein the one or more communications comprise at least one of an alert, an account notice, or a request for additional information;
selecting a first communication from the one or more communications to send to the user;
determining whether one or more restrictions on receiving communications have been enabled; and
based on the activating the trigger and based on a determination that the user has not enabled one or more restrictions on receiving communications, sending the first communication to a user device.

2. The method of claim 1, comprising:
sending, to the third party, a response to the request to access information.

3. The method of claim 1, wherein the third party comprises a server associated with the third-party application.

4. The method of claim 1, wherein the third-party application comprises a financial aggregator application.

5. The method of claim 1, wherein the determination that the request to access information was a user-initiated request comprises:
determining, using the machine learning model, that the request to access information is not a batch request based on at least one of: a time of the request; a number of requests that are similar to the request; or a service level agreement.

6. The method of claim 1, comprising:
determining a type of information associated with the request to access information; and
selecting, based on a determination of the type of information associated with the request to access information, the first communication.

7. The method of claim 1, wherein the sending the first communication comprises sending at least one of:
a push notification to a mobile device;
an electronic communication; or
a pre-recorded communication via a phone call.

8. The method of claim 1, comprising:
monitoring whether the user engages with the first communication, wherein the user engages with first communication by at least one of:
opening the first communication; or
selecting one or more links in the first communication; and
updating, based on a determination that the user engages with the first communication, one or more algorithms used to select the one or more communications sent to the user.

9. A server comprising:
one or more processors;
memory storing instructions that, when executed by the one or more processors, cause the server to:
receive a request to access information relating to an account associated with a user, wherein the request to access information comprises a first identifier indicating a party making the request, a second identifier indicating the account, and a third identifier indicating authorization to access the account;
determine whether the party making the request is a third party;
determine whether the request to access information was initiated by the user via the third party, wherein determining whether the request to access information was initiated by the user via the third party comprises using a machine learning model trained to predict a user-initiated request;
determine, based on a determination that the party making the request is a third party and that the request to access information was a user-initiated request, that the user is accessing the account via a third-party application;
activate, based on a determination that the user is accessing the account via the third-party application, a trigger associated with user outreach;
determine, based on activating the trigger, that one or more communications are pending for the user;
select a first communication from the one or more communications to send to a user device;
determine whether one or more restrictions on receiving communications have been enabled; and
send, based on activating the trigger and based on a determination that the user has not enabled one or more restrictions on receiving communications, the first communication to the user device.

10. The server of claim 9, wherein the user device comprises a financial aggregator application associated with the third party.

11. The server of claim 9, wherein the instructions, when executed by the one or more processors, cause the server to:
determine, using the machine learning model, that the request to access information is not a batch request based on at least one of: a time of the request; a number of requests that are similar to the request; or a service level agreement.

12. The server of claim 9, wherein the instructions, when executed by the one or more processors, cause the server to:
determine a type of information associated with the request to access information; and
select, based on a determination of the type of information associated with the request to access information, the first communication.

13. The server of claim 9, wherein sending the first communication to the user device comprises sending at least one of:
a push notification to a mobile device;
an electronic communication; or
a pre-recorded communication via a phone call.

14. The server of claim 9, wherein the instructions, when executed by the one or more processors, cause the server to:
determine whether the user interacted with the first communication; and
update, based on a determination that the user interacted with the first communication, one or more algorithms used to select the one or more communications sent to the user.

15. One or more non-transitory media storing instructions that, when executed by one or more processors, cause the one or more processors to perform steps comprising:
receiving, by a first device, a request to access information relating to an account associated with a user, wherein the request to access information comprises a first identifier indicating a party making the request, a second identifier indicating the account, and a third identifier indicating authorization to access the account;
determining whether the party making the request is a third party;
determining whether the request to access information was initiated by the user via the third party, wherein the determining that the request to access information was user-initiated by the user via the third party comprises using a machine learning model trained to predict whether a user initiated the request;
determining that the user is accessing the account via a third-party application based on a determination that the party making the request is a third party and that the request to access information was a user-initiated request;
activating, based on a determination that the party making the request is a third party and the request to access information was user-initiated, a trigger associated with user outreach;
determining, based on the activating the trigger, that one or more communications are pending for the user, wherein the one or more communications comprise at least one of an alert, an account notice, or a request for additional information;
selecting a first communication from the one or more communications to send to the user;
determining whether one or more restrictions on receiving communications have been enabled;
sending, based on the activating the trigger and based on a determination that the user has not enabled one or more restrictions on receiving communications, the first communication; and
sending, to the third party, a response to the request to access information.

16. The one or more non-transitory media of claim 15, wherein the third party comprises a server associated with a financial aggregator application.

17. The one or more non-transitory media of claim 15, wherein the instructions cause the one or more processors to perform steps comprising:
determining, using the machine learning model, that the request to access information is not a batch request based on at least one of: a time of the request; a number of requests that are similar to the request; or a service level agreement.

18. The one or more non-transitory media of claim 15, wherein the instructions cause the one or more processors to perform steps comprising:
determining a type of information associated with the request to access information; and
selecting, based on a determination of the type of information associated with the request to access information, the first communication.

19. The one or more non-transitory media of claim 15, wherein the sending the first communication comprises sending at least one of:
a push notification to a mobile device;
an electronic communication; or
a pre-recorded communication via a phone call.

20. The one or more non-transitory media of claim 15, wherein the instructions cause the one or more processors to perform steps comprising:
updating, based on a determination that the user engaged with the first communication, one or more algorithms used to select the one or more communications sent to the user.
